(19) United States
(12) Patent Application Publication
(10) Pub. No.: US 2024/0262408 A1
(43) Pub. Date: Aug. 8, 2024

(54) ELECTRICAL DISTRIBUTION SYSTEM FOR ACTIVELY COOLED TOTES

(71) Applicant: Phononic, Inc., Durham, NC (US)

(72) Inventors: Michael Canaday, Durham, NC (US); Ed Karwacki, Garner, NC (US); Michael Hash, Raleigh, NC (US); Sheldon Muir, Durham, NC (US)

(21) Appl. No.: 18/433,316

(22) Filed: Feb. 5, 2024

Related U.S. Application Data
(60) Provisional application No. 63/443,220, filed on Feb. 3, 2023.

(51) Int. Cl. B62B 3/10; H02J 7/00; H02J 50/40

(52) U.S. Cl. CPC B62B 3/106; H02J 7/00032; H02J 7/0045; H02J 7/0048; H02J 7/0063; H02J 50/40; B62B 2204/04

(57) ABSTRACT

An electrical distribution system for actively cooled totes is provided. In some embodiments, a transportation cart for providing power to one or more cooled totes, includes: wheels for allowing the transportation cart for moving; one or more tote placement locations; a battery for storing power; and a power subsystem for providing power to at least one of the one or more tote placement locations. This provides additional cold chain compliance while making picking easier and less hurried.

### RELATED APPLICATIONS

This application claims the benefit of provisional patent application Ser. No. 63/443,220, filed Feb. 3, 2023, the disclosure of which is hereby incorporated herein by reference in its entirety.

### FIELD OF THE DISCLOSURE

The disclosure relates generally to temperature-controlled environments.

### BACKGROUND

Cold chain transport for food, drug or any products that need temperature control for delivery currently is done with tri temperature or refer trucks and vans upfitted with compressor based systems that cool or freeze the entire sectioned area of a truck and must be run constantly to maintain temperature inside the truck. Whether the truck has one gallon of milk or a pint of ice cream, the entire space must be cooled or frozen. Compressor based refer trucks and tri temp trucks or vans must be penetrated from the outside to get the cooling platform of a compressor-based system inside the truck or van, which voids the warranty of the van or truck. In addition, to run tri temperature trucks, dividers must exist between the temperature zones to maintain temperature. The separation of space requires separation of orders that have goods in two or more zones. Compressor based systems pull too much power for the system to be placed in or on a fully electric vehicle without degrading the range of the vehicle significantly. Improved systems and methods for thermal management are needed.

### SUMMARY

An electrical distribution system for actively cooled totes is provided. In some embodiments, a transportation cart for providing power to one or more cooled totes, includes: wheels for allowing the transportation cart for moving; one or more tote placement locations; a battery for storing power; and a power subsystem for providing power to at least one of the one or more tote placement locations. This provides additional cold chain compliance while making picking easier and less hurried.

In some embodiments, the one or more tote placement locations includes an electrical contact to provide power to a cooled tote. In some embodiments, the electrical contact is an Anderson Plug.

In some embodiments, the one or more tote placement locations includes a wireless power source to provide power to a cooled tote.

In some embodiments, the one or more tote placement locations are only powered if a cooled tote is interfaced with the tote placement location.

In some embodiments, the transportation cart also includes a communication interface to provide one or more of a group consisting of: a status of the presence of a tote on the one or more tote placement locations; a battery level of one or more totes on the one or more tote placement locations; a temperature of one or more totes on the one or more tote placement locations; a battery level of the transportation cart; a status of charging the transportation cart; and a location of the transportation cart.

In some embodiments, the one or more tote placement locations can be provided different amounts of power depending on the cooled tote associated with the one or more tote placement locations.

In some embodiments, the transportation cart includes two, four, or six tote placement locations.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A-1D illustrate utilization of a portable, self-contained, refrigeration or freezing system, coupled with integrated automated controls and monitoring;

FIG. 2 and FIGS. 3A and 3B illustrate an example embodiment of an active cooler in accordance with embodiments of the present disclosure;

FIG. 4 illustrates a system including an active cooler in accordance with some embodiments of the present disclosure;

FIG. 5 illustrates an example of a tote as discussed herein;

FIGS. 6A and 6B illustrate that different versions of the totes could be used in refrigerator or freezer versions;

FIG. 7 shows an exploded view of the tote that includes a thermoelectric unit as discussed herein;

FIG. 8 shows the standard tri-temperature truck that is used for deliveries;

FIG. 9 illustrates a delivery truck which does not need refrigeration systems or needs less;

FIG. 10 illustrates a proposed cart architecture for discrete, rapid, and zone order picking with electrical power for two to six temperature-controlled totes, according to some embodiments of the current disclosure;

FIG. 11 illustrates a Circuit Wiring Diagram with Anderson Plug, according to some embodiments of the current disclosure;

FIG. 12 illustrates a Circuit Wiring Diagram with Copper Contacts and Brushes, according to some embodiments of the current disclosure;

FIG. 13 illustrates a Wiring Diagram of the AC-DC Power Distribution Module, according to some embodiments of the current disclosure;

FIG. 14 illustrates a Logic Table, according to some embodiments of the current disclosure;

FIG. 15 illustrates an example of tote placement for discrete pick type, according to some embodiments of the current disclosure;

FIG. 16 illustrates an example of tote placement for express pick type, according to some embodiments of the current disclosure; and

FIG. 17 illustrates an example of tote placement for zone pick type, according to some embodiments of the current disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Last mile delivery of food requires temperature-controlled transport of perishable food items using transit vans or similar vehicles. For temperature control, refrigerated or freezer totes can be used which are installed in the van (e.g., a cargo van) or a box truck.

These totes use an active heat pump to pull heat from an enclosed chamber and reject it to surrounding ambient. The hot air must be removed from the van to ensure optimum operation of the totes.

These totes require power while in transit maintain food safety requirements for perishable consumption. The electrical system needs to reach (and/or maintain) the correct temperature must be met for operation of the totes.

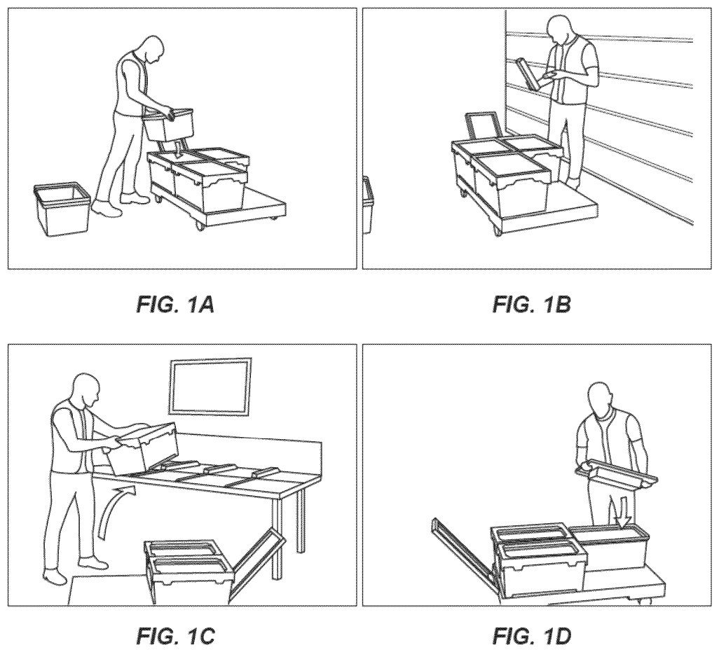

FIGS. 1A-1D illustrate utilization of a portable, self-contained, refrigeration or freezing system, coupled with integrated automated controls and monitoring.

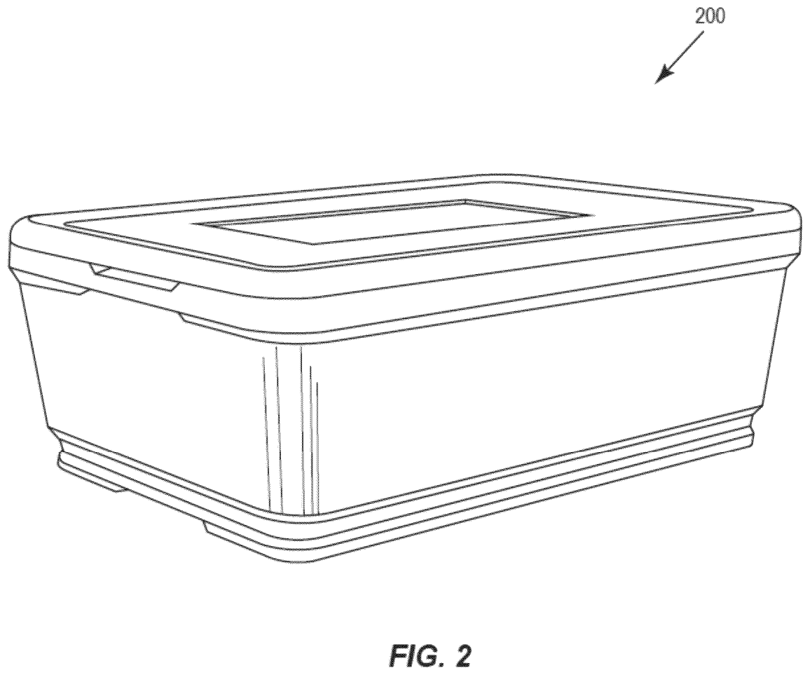

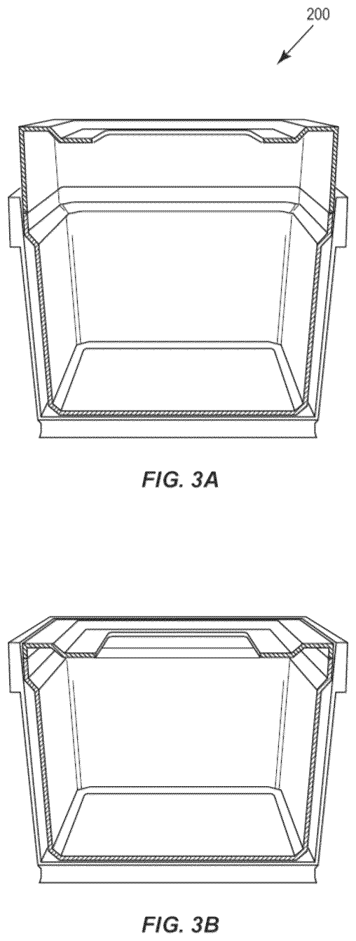

FIG. 2 and FIGS. 3A and 3B illustrate an example embodiment of an active cooler in accordance with embodiments of the present disclosure.

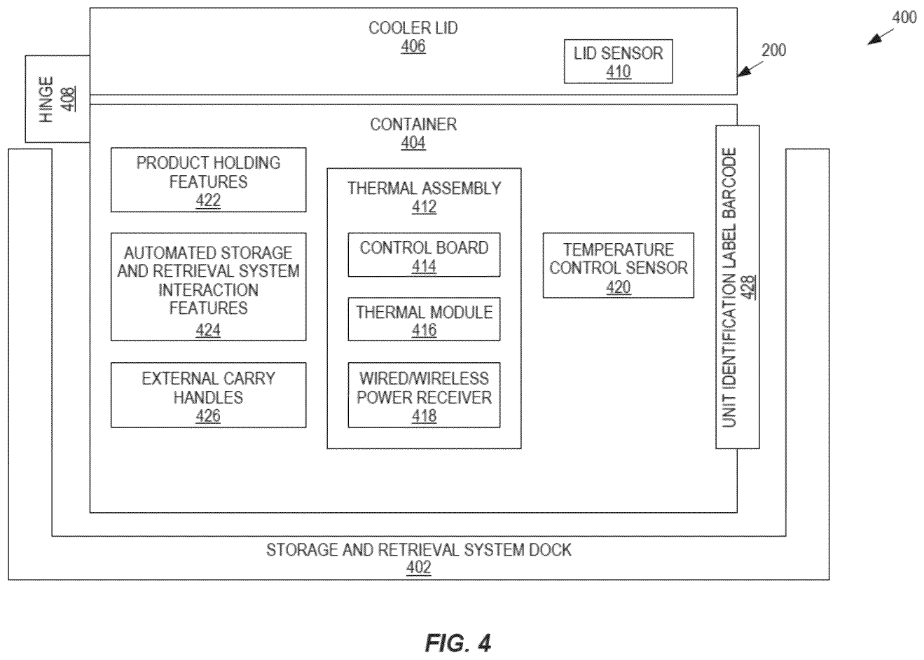

FIG. 4 illustrates a system including an active cooler in accordance with some embodiments of the present disclosure.

For more details, the interested reader is directed to U.S. Provisional Patent Application Ser. No. 62/953,771, entitled THERMOELECTRIC REFRIGERATED/FROZEN PRODUCT STORAGE AND TRANSPORTATION COOLER; U.S. patent application Ser. No. 17/135,420, entitled THERMOELECTRIC REFRIGERATED/FROZEN PRODUCT STORAGE AND TRANSPORTATION COOLER, now U.S. Patent Application Publication No. 2021/0199353 A1; and International Patent Application No. PCT/US2020/067172, entitled THERMOELECTRIC REFRIGERATED/FROZEN PRODUCT STORAGE AND TRANSPORTATION COOLER, now International Patent Publication No. WO 2021/134068. These applications are hereby incorporated herein by reference in their entirety.

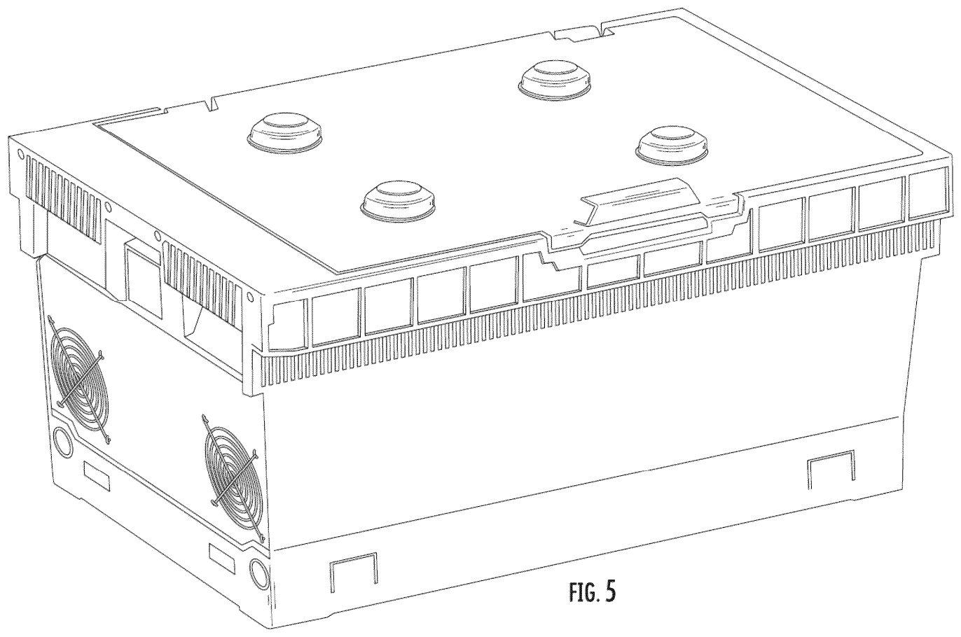

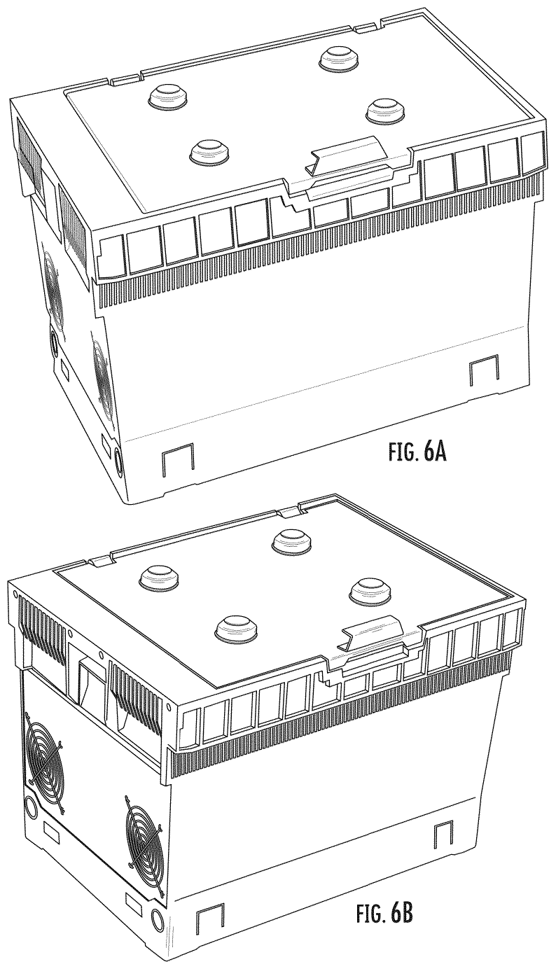

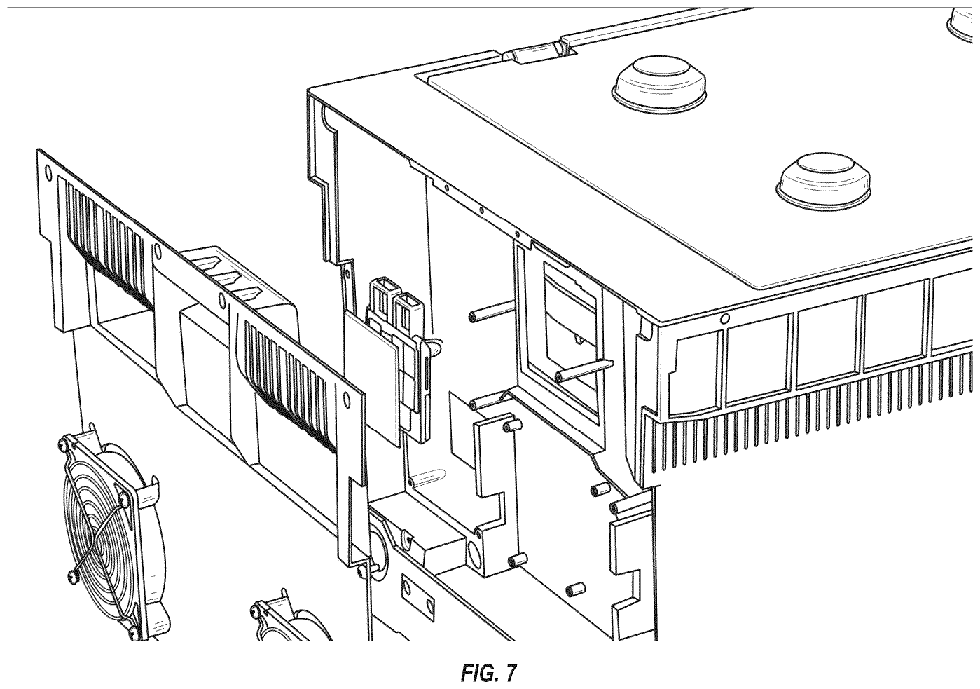

FIG. 5 illustrates an example of a tote as discussed herein. FIGS. 6A and 6B illustrate that different versions of the totes could be used in refrigerator or freezer versions. FIG. 7 shows an exploded view of the tote that includes a thermoelectric unit as discussed herein.

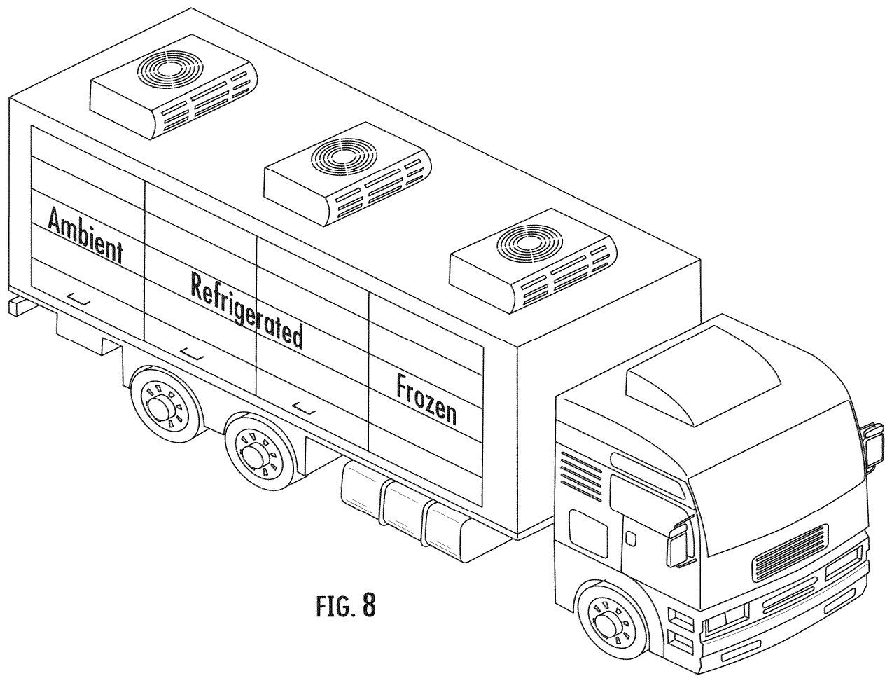

FIG. 8 shows the standard tri-temperature truck that is used for deliveries. This might include several different cooling systems that must be carried around regardless of whether they are currently needed.

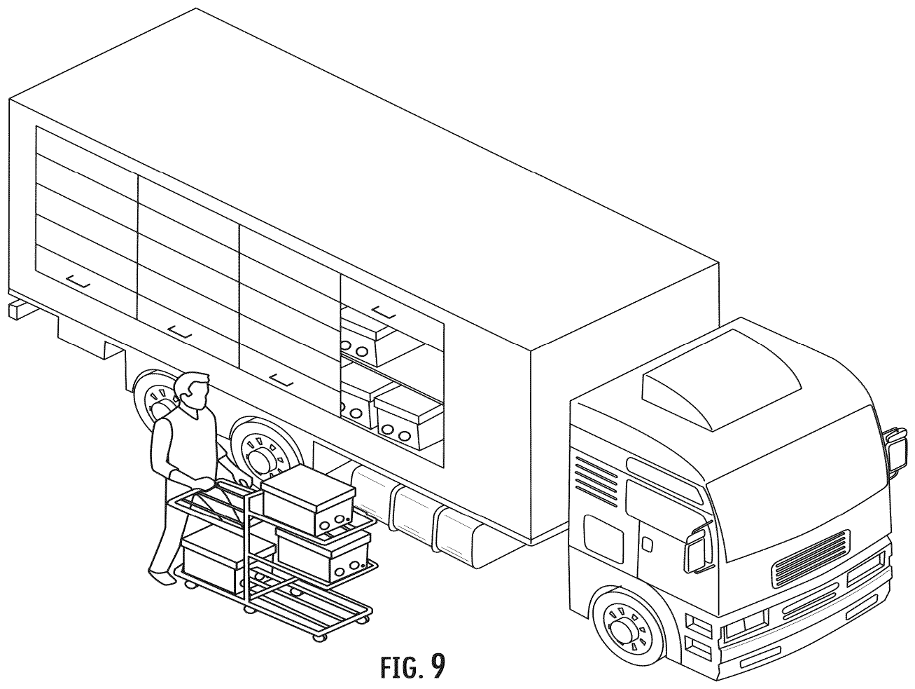

FIG. 9 illustrates a delivery truck which does not need refrigeration systems or needs less. In this embodiment, the totes provide the proper temperatures for the various goods. This can make the trucks more efficient in many ways. This also adds configurability. If an entire truck is needed for a specific temperature, this can be easily accomplished as opposed to the standard truck. These trucks might include charging capabilities or other amenities.

Retail grocery picking of food for online customer orders requires temperature-controlled storage of perishable food items awaiting customer pickup. Temperature-controlled totes, refrigerated or freezer, can be installed on a grocery picking cart or conditioning rack.

These totes require power when the order picking is complete, and the cart is ready for storage to maintain food safety requirements for perishable consumption. The electrical system must reach and maintain the correct temperature must be met to ensure the optimum operation of the totes.

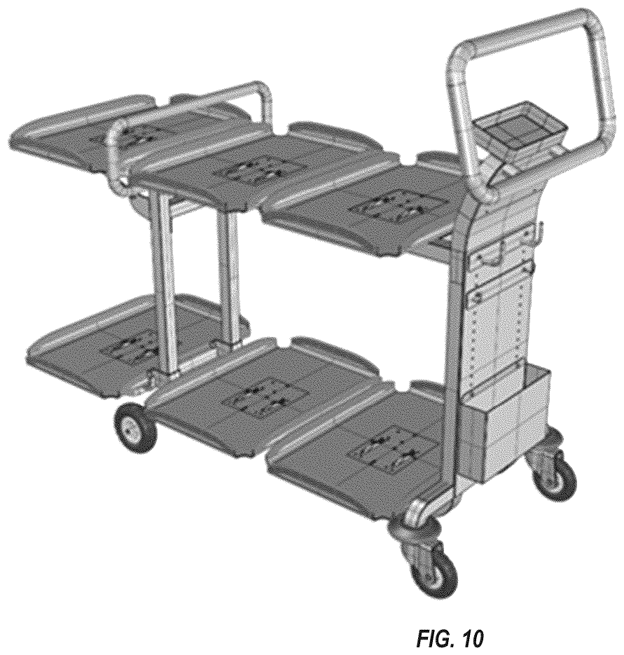

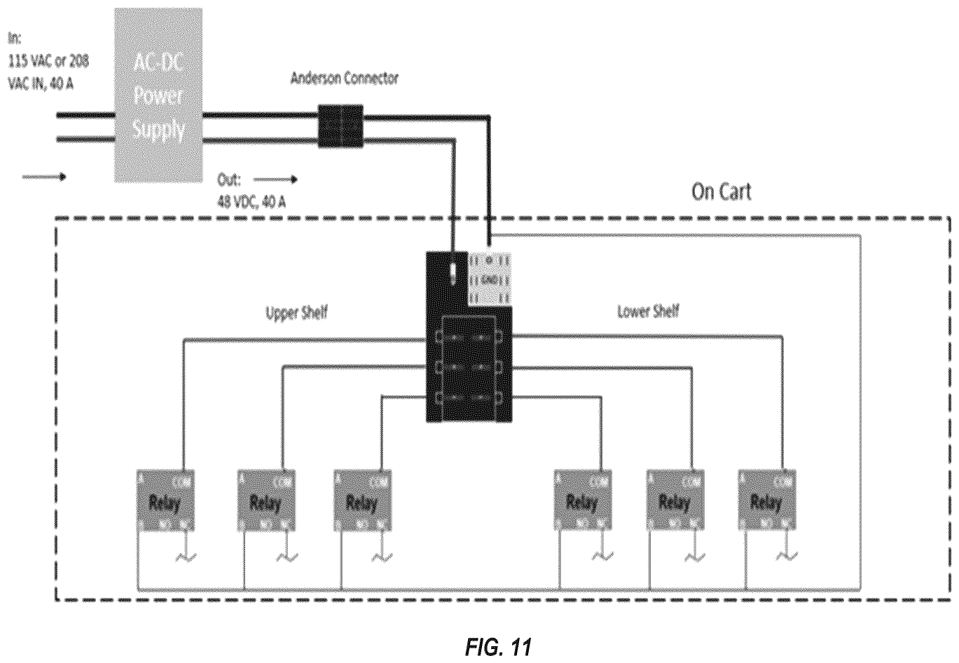

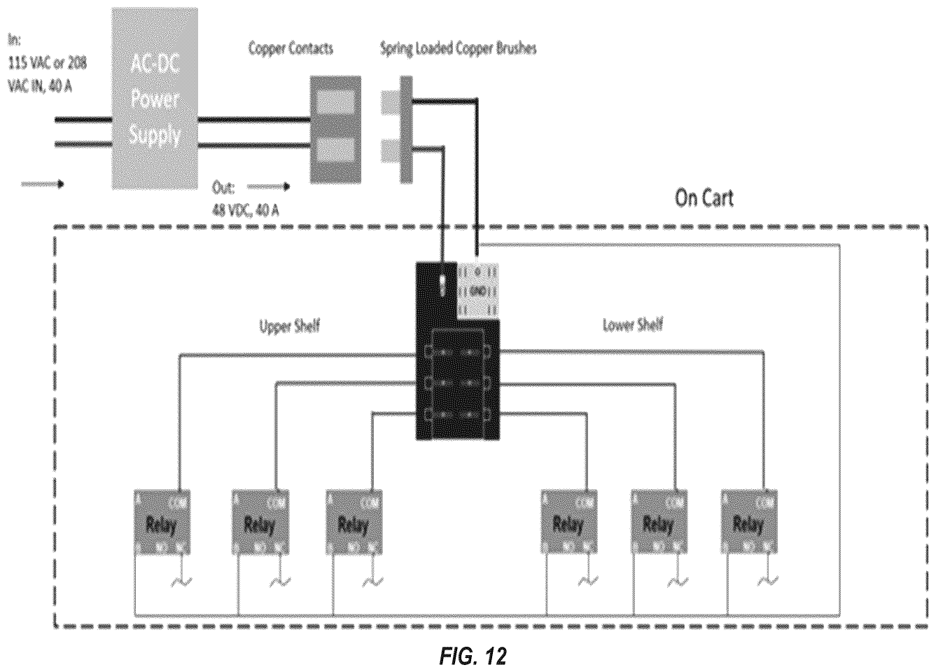

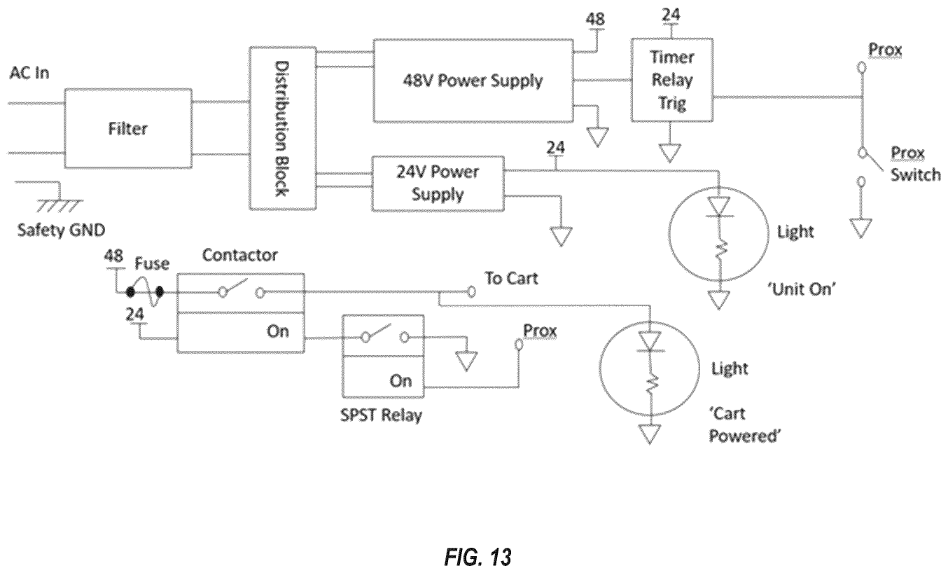

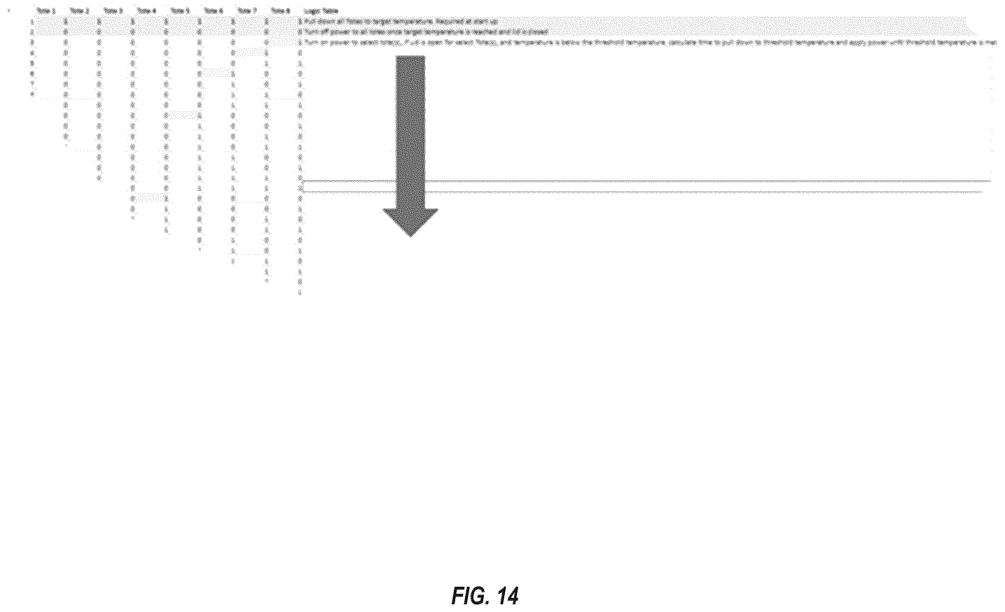

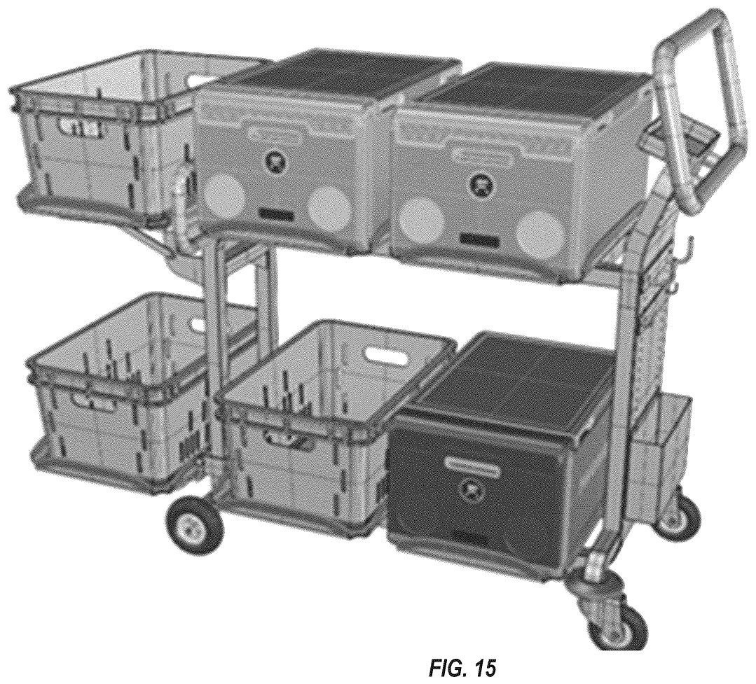

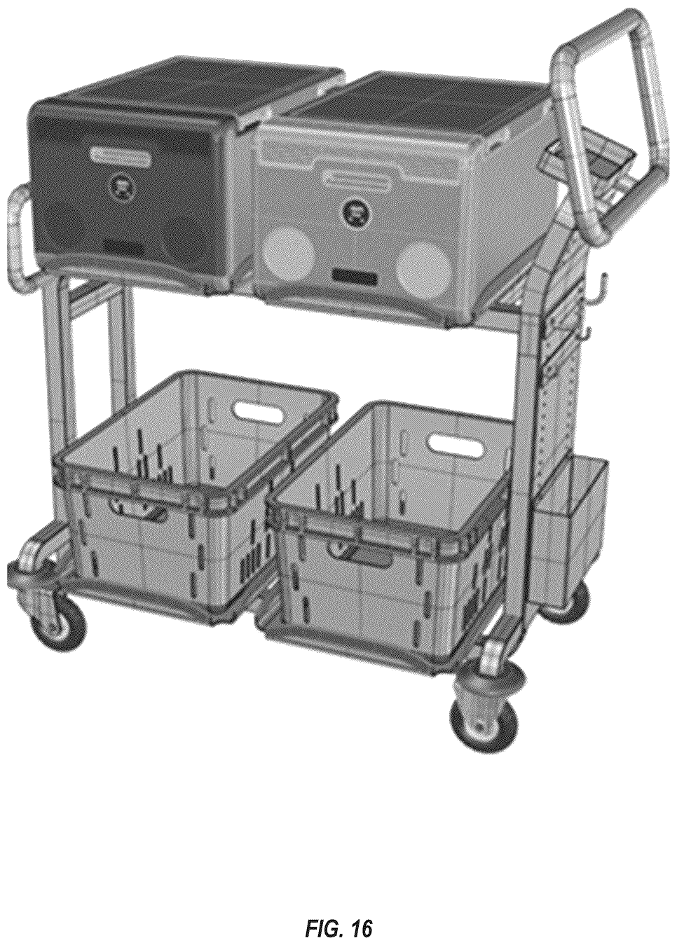

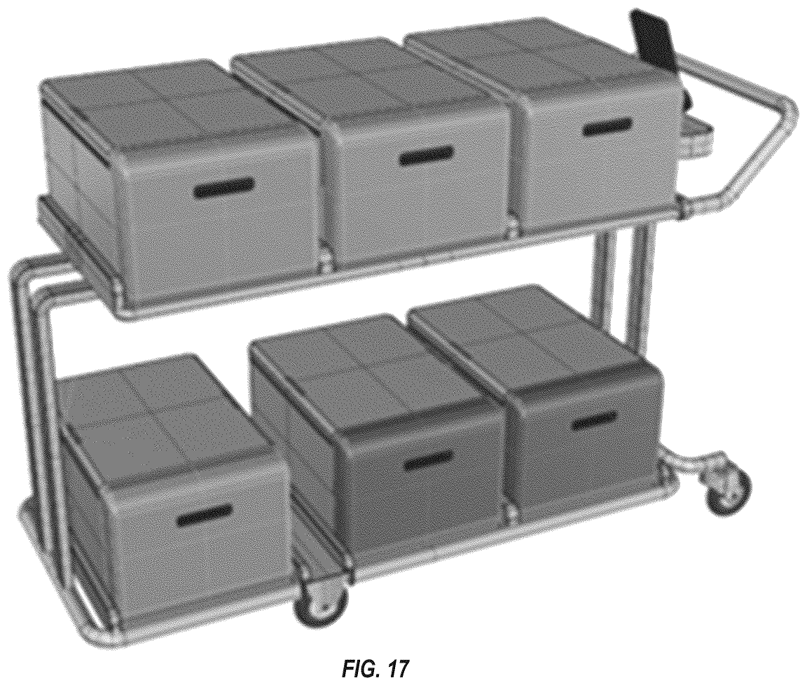

FIG. 10 illustrates a proposed cart architecture for discrete, rapid, and zone order picking with electrical power for two to six temperature-controlled totes. FIG. 11 illustrates a Circuit Wiring Diagram with Anderson Plug. FIG. 12 illustrates a Circuit Wiring Diagram with Copper Contacts and Brushes. FIG. 13 illustrates a Wiring Diagram of the AC-DC Power Distribution Module. FIG. 14 illustrates a Logic Table. FIG. 15 illustrates an example of tote placement for discrete pick type. In some embodiments, only locations displaying actively cooled totes are powered. FIG. 16 illustrates an example of tote placement for express pick type. In some embodiments, only locations displaying actively cooled totes are powered. FIG. 17 illustrates an example of tote placement for zone pick type.

In some embodiments, an electrical distribution comprising a polarity of AC-DC power supply sized to meet the power requirements of the polarity of thermal electric Tote, power cables sized for the power rating, power connectors, a power distribution block with a polarity of connection points, a current and voltage monitoring system, polarity of relays, and an active thermal electric Tote.

Some embodiments include copper contacts and copper brushes to supply DC voltage to the cart instead of the Anderson Connector. Copper brushes are mounted to the wall or onto substructure and contact pads would mount on the cart frame.

Some embodiments include the same copper contact with magnets to attract them to one another. This would be configured as a cable coming from the power distribution module and contact box attached to the cart frame.

In some embodiments, the power distribution module comprising of an AC-DC power supply sized to meet the pawer requirements of the thermal electric Tote, a secondary AC-DC power supply sized to control the user indicator lights and relays, power cables sized for the AC and DC power ratings, an inline AC filter, proximity switch to detect the presence of cart and control, contactor to control power delivery to the cart. The indicator lights are feedback to the cart user to verify that the power module is receiving power from the wall and that the power module is delivering power to the cart.

Some embodiments include a processor and tuned logic used to optimize charging time and power distribution during; conditioning of the Tote by pulling down the temperature of an active Tote to the desired target temperature, maintaining temperature during idle state, and maintaining threshold temperature during active use.

In some embodiments, the cart is configured with onboard display, light, or user interface which is connected to IoT allowing the user to easily identify which picking cart is tied to the customer's order. This allows for quick identification of orders for delivery to customers.

Those skilled in the art will recognize improvements and modifications to the preferred embodiments of the present disclosure. All such improvements and modifications are considered within the scope of the concepts disclosed herein and the claims that follow.

1. A transportation cart for providing power to one or more cooled totes, comprising:
wheels for allowing the transportation cart for moving;
one or more tote placement locations;
a battery for storing power; and
a power subsystem for providing power to at least one of the one or more tote placement locations.

2. The transportation cart of claim 1 wherein the one or more tote placement locations includes an electrical contact to provide power to a cooled tote.

3. The transportation cart of claim 2 wherein the electrical contact is an Anderson Plug.

4. The transportation cart of claim 1 wherein the one or more tote placement locations includes a wireless power source to provide power to a cooled tote.

5. The transportation cart of claim 1 wherein the one or more tote placement locations are only powered if a cooled tote is interfaced with the tote placement location.

6. The transportation cart claim 1 further comprising:
a communication interface to provide one or more of a group consisting of:
a status of the presence of a tote on the one or more tote placement locations;
a battery level of one or more totes on the one or more tote placement locations;
a temperature of one or more totes on the one or more tote placement locations;
a battery level of the transportation cart;
a status of charging the transportation cart; and
a location of the transportation cart.

7. The transportation cart of claim 1 wherein the one or more tote placement locations can be provided different amounts of power depending on the cooled tote associated with the one or more tote placement locations.

8. The transportation cart of claim 1 comprising two tote placement locations.

9. The transportation cart of claim 1 comprising four tote placement locations.

10. The transportation cart of claim 1 comprising six tote placement locations.
